(19) United States
(12) Patent Application Publication
(10) Pub. No.: US 2021/0176405 A1
(43) Pub. Date: Jun. 10, 2021

(54) ELECTRONIC DEVICE, CONTROLLER DEVICE, AND CONTROL METHOD

(71) Applicant: SHARP KABUSHIKI KAISHA, Sakai City (JP)

(72) Inventor: YASUSHI ISHII, Sakai City (JP)

(21) Appl. No.: 17/112,019

(22) Filed: Dec. 4, 2020

(30) Foreign Application Priority Data
Dec. 10, 2019 (JP) 2019-222824

(51) Int. Cl. H04N 5/232; H04N 5/369; H04N 13/25

(52) U.S. Cl. CPC H04N 5/232411; H04N 13/25; H04N 5/3698

(57) ABSTRACT

An electronic device includes a first camera that performs a shooting operation in accordance with a user operation; at least one second camera different from the first camera; and a controller device that controls the first camera and the second camera, wherein the controller device performs a determination process in which a degree of importance of a scene for the shooting operation is determined by using an image shot by the first camera and a camera control process in which switching of an operation mode of the second camera is performed based on the degree of importance, the switching being performed between a shooting mode in which a shooting operation is performed and a low power consumption mode in which power consumption is lower than power consumption in the shooting operation.

### BACKGROUND

### 1. Field

The present disclosure relates to an electronic device, a controller device, and a control method.

### 2. Description of the Related Art

To date, a technology for obtaining respective images from a plurality of cameras installed in one electronic device is known.

However, the technology as described above has the following issue to be discussed. For example, in a case where a plurality of cameras are included in one electronic device, like a compound-eye digital camera described in Japanese Unexamined Patent Application Publication No. 2011-205530, simultaneous operations of the plurality of cameras for shooting images cause high power consumption. In particular, if the electronic device is a battery driven device, high battery consumption leads to considerably high power consumption. In addition, heat generation involved with the power consumption is not ignored. In particular, a device having closely arranged small and precise mechanisms has the considerably high power consumption.

It is desirable to reduce power consumption of an electronic device having a plurality of cameras.

### SUMMARY

According to an aspect of the disclosure, there is provided an electronic device including a first camera that performs a shooting operation in accordance with a user operation, at least one second camera different from the first camera, and a controller device that controls the first camera and the second camera. The controller device performs a determination process and a camera control process. In the determination process, a degree of importance of a scene for the shooting operation is determined by using an image shot by the first camera. In the camera control process, switching of an operation mode of the second camera is performed based on the degree of importance. The switching is performed between a shooting mode in which a shooting operation is performed and a low power consumption mode in which power consumption is lower than power consumption in the shooting operation.

According to an aspect of the disclosure, there is provided a controller device that controls an electronic device including a first camera that performs a shooting operation in accordance with a user operation and at least one second camera different from the first camera. The controller device includes a determination unit and a camera controller. The determination unit determines a degree of importance of a scene for the shooting operation. The degree of importance is determined by using an image shot by the first camera. The camera controller performs switching of an operation mode of the second camera based on the degree of importance. The switching is performed between a shooting mode in which a shooting operation is performed and a low power consumption mode in which power consumption is lower than power consumption in the shooting operation.

According to an aspect of the disclosure, there is provided a control method for an electronic device including a first camera that performs a shooting operation in accordance with a user operation and at least one second camera different from the first camera. The method includes determining, by using an image shot by the first camera, a degree of importance of a scene for the shooting operation and camera controlling in which switching an operation mode of the second camera is performed based on the degree of importance. The switching is performed between a shooting mode in which a shooting operation is performed and a low power consumption mode in which power consumption is lower than the power consumption in the shooting operation.

### BRIEF DESCRIPTION OF THE DRAWINGS

FIG. 1 is a block diagram illustrating the configuration of principal components of a smartphone that is an example of an electronic device;

FIG. 2 is a timing chart illustrating scenes for a shooting operation and the operation of the smartphone according to Embodiment 1 in a time series;

FIG. 3 is a table illustrating an example data structure of degree-of-importance determination rule information stored in the smartphone according to Embodiment 1;

FIG. 4 is a flowchart illustrating an example flow of a process executed by the smartphone according to Embodiment 1;

FIG. 5 is a flowchart illustrating an example flow of a degree-of-importance determination process executed by a determination unit according to Embodiment 1;

FIG. 6 is a timing chart illustrating scenes for a shooting operation and the operation of the smartphone according to Embodiment 2 in a time series;

FIG. 7 is a table illustrating an example data structure of degree-of-importance determination rule information stored in the smartphone according to Embodiment 2;

FIG. 8 is a flowchart illustrating an example flow of a process executed by the smartphone according to Embodiment 2;

FIG. 9 is a flowchart illustrating an example flow of a degree-of-importance determination process executed by the determination unit according to Embodiment 2;

FIG. 10 is a timing chart illustrating scenes for a shooting operation and the operation of the smartphone according to Embodiment 3 in a time series;

FIG. 11 is a table illustrating an example data structure of degree-of-importance determination rule information stored in the smartphone according to Embodiment 3;

FIG. 12 is a flowchart illustrating an example flow of a degree-of-importance determination process executed by the determination unit according to Embodiment 3; and

FIG. 13 is a schematic block diagram illustrating the configuration of principal components of a second camera.

### DESCRIPTION OF THE EMBODIMENTS

### Embodiment 1

Hereinafter, an embodiment of the present disclosure will be described in detail. This embodiment is described on the assumption that an electronic device of this disclosure is, for example, a smartphone having a plurality of cameras. However, the electronic device of the disclosure is not limited to the smartphone and may be any electronic device likely to have a plurality of cameras such as a digital camera, a video camera, a mobile phone, a tablet, or a gaming device.

### Configuration of Smartphone

### Hardware Configuration

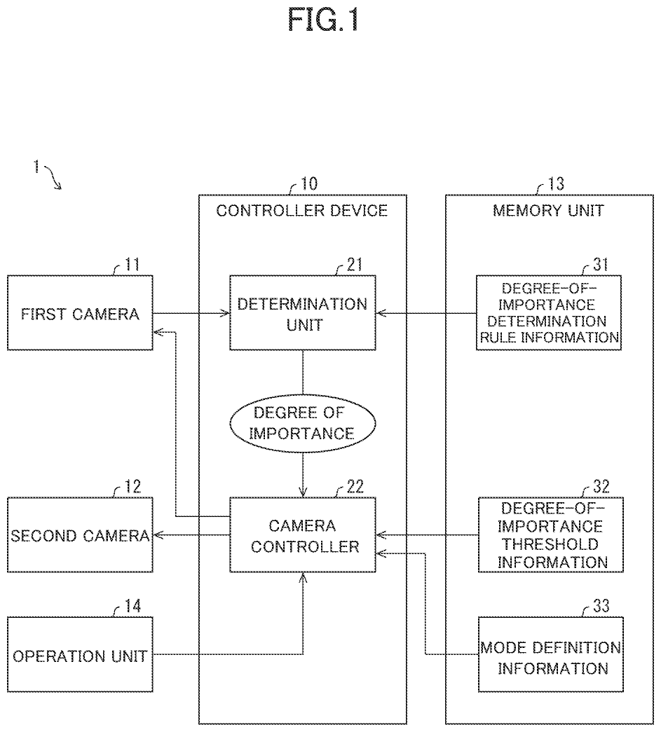

FIG. 1 is a block diagram illustrating the configuration of principal components of a smartphone 1. The smartphone 1 includes, for example, a controller device 10, a memory unit 13, a first camera 11, a second camera 12, and an operation unit 14. To implement functions of a general smartphone, the smartphone 1 may further include various standard components (not illustrated) of the smartphone.

The operation unit 14 is an input device that receives an operation by a user and outputs an instruction signal responding to the operation to the controller device 10. In an example, the operation unit 14 may be configured as a touch panel together with a display unit (not illustrated). The operation unit 14 is configured as a device capable of detecting a touch with an instructing object such as a finger of the user on the input surface of the operation unit 14 and approach of the instructing object thereto. The input surface also serves as the display surface of the display unit.

For example, user interface (UI) components such as software buttons for operating the first camera 11 (described later) are displayed on the display unit. The user touches the UI components and may thereby instruct the controller device 10 to cause the first camera 11 to perform an intended shooting operation.

In another example, the operation unit 14 may include an input mechanism such as a hardware button for inputting an instruction signal.

The first camera 11 shoots a scene as a shooting target and generates a still image or a moving image. The first camera 11 performs a shooting operation under the control of a camera controller 22 (described later) in accordance with an operation performed by the user by using the operation unit 14. Hereinafter, when not have to be discriminated from each other, each of a still image and a moving image is generally referred to as an image.

The second camera 12 shoots a scene as a shooting target and generates an image. The second camera 12 performs a predetermined shooting operation under the control of the camera controller 22 (described later). Specifically, as to be described later, the memory unit 13 stores mode definition information 33 defining the shooting operations of the second camera 12 in advance. The second camera 12 performs a shooting operation based on the mode definition information 33 in accordance with a control signal generated by the camera controller 22.

In an example, the first camera 11 and the second camera 12 each include an imaging device that converts light from the shooting target to an electric signal, such as a charge coupled device (CCD) or a complementary metal-oxide semiconductor (CMOS), and an image processing circuit that converts the electric signal from the imaging device to digital data regarding RGB colors. Images captured by the first camera 11 and the second camera 12 are stored in a predetermined area of the memory unit 13 under the control of the controller device 10.

The shooting operation of the second camera 12 may be the same as the shooting operation of the first camera 11 and may be different therefrom. If the second camera 12 performs a shooting operation different from that of the first camera 11, the smartphone 1 may acquire a plurality of images shot for the same scene by different shooting methods at the same time.

In an example, when the first camera 11 shoots the whole scene in a wide view to generate a bird-eye image, a zoom-out image, or the like, the second camera 12 may zoom in to shoot a specific subject in the screen to generate a closeup image, a zoom-in image, or the like. In another example, when the first camera 11 shoots a scene at a predetermined frame rate, the second camera 12 may acquire a slow image by shooting the scene at a frame rate higher than the predetermined frame rate. This enables the first camera 11 to provide a moving image moving at a normal speed and the second camera 12 to provide a moving image slowly moving in the same time period and representing the same scene as for the first camera 11.

The controller device 10 controls the operations of the components of the smartphone 1 and is configured as, for example, a computer including an arithmetic processing unit such as a central processing unit (CPU) or a dedicated processor. The controller device 10 runs a program for various control over the smartphone 1 stored in the memory unit 13 after reading out the program and thereby comprehensively controls the operations of the components of the smartphone 1. The details of the controller device 10 will be described later.

The memory unit 13 stores various pieces of data to be used by the controller device 10 and includes a random access memory (RAM), a read only memory (ROM), and the like. In this embodiment, for example, the memory unit 13 stores degree-of-importance determination rule information 31 and the mode definition information 33 in a nonvolatile manner. Degree-of-importance threshold information 32 may be stored in a nonvolatile manner as occasion arises but may be omitted.

The degree-of-importance determination rule information 31 is information defining the scene of which the degree of importance is determined and how the degree of importance is determined. The scene is represented by an image shot by the first camera 11. The degree of importance is an index obtained by quantifying the importance of a scene for a shooting operation. In an example in this disclosure, the degree of importance is expressed by using a numerical value, and a higher numerical value denotes a more important scene. In another example, the value may be decided in such a manner that a lower degree of importance value denotes higher importance of the scene. In still another example, the degree of importance may be expressed by using a symbol other than the numerical value. A determination unit 21 (described later) refers to the degree-of-importance determination rule information 31 to determine the degree of importance of a scene.

The degree-of-importance threshold information 32 is threshold information used as a condition for deciding an operation mode to be used by the second camera 12. The camera controller 22 (described later) refers to the degree-of-importance threshold information 32 to decide an operation mode to be used by the second camera 12.

The mode definition information 33 is information defining operation modes to be used by the second camera 12. In this embodiment, for example, there are a shooting mode and a low power consumption mode as the operation modes to be used by the second camera 12. The shooting mode corresponds to a first operation mode of the second camera 12 in which a shooting operation is performed. The low power consumption mode corresponds to a second operation mode of the second camera 12 in which operations are performed with power consumption lower than the power consumption in the shooting operation in the shooting mode. The mode definition information 33 includes information defining the specific details of the shooting operation of the second camera 12 in the shooting mode and the operation of the second camera 12 in the low power consumption mode. The camera controller 22 refers to the mode definition information 33 to decide the operation to be performed by the second camera 12. The mode definition information 33 may be included in the smartphone 1 at shipping in advance or may be set optionally by the user later.

Operations having lower power consumption in the low power consumption mode than that in the shooting operation in the shooting mode may include a low-power shooting operation for shooting an image in power consumption lower than that in the shooting operation in the shooting mode.

### Software Configuration

The camera controller 22 transmits control signals to the components of the first camera 11 and the second camera 12 and thereby controls the operations of the components. The camera controller 22 transmits a control signal responding to the operation performed by the user on the operation unit 14 to the first camera 11 and causes the first camera 11 to perform a shooting operation in accordance with the user operation.

The camera controller 22 controls the operation of the second camera 12 in accordance with the degree of importance of a scene determined by using an image shot by the first camera 11.

The determination unit 21 determines the degree of importance indicating the importance of a scene for the shooting operation. Specifically, the determination unit 21 determines the degree of importance of a scene shot by the first camera 11 by using a numerical value. If the determination unit 21 determines that the current scene is important by using an image being currently shot by the first camera 11, the determination unit 21 outputs the degree of importance having a high numerical value to the camera controller 22. If the determination unit 21 determines that the current scene is not important by using the image, the determination unit 21 outputs the degree of importance having a low numerical value to the camera controller 22.

Although how the determination unit 21 determines the degree of importance is not particularly limited, for example, the following method is usable. In a first usable method, determination rules are set in advance, the determination unit 21 determines the degree of importance of the scene in accordance with the determination rules. In this embodiment, the degree-of-importance determination rule information 31 is stored in the memory unit 13 as the determination rules described above. The determination unit 21 may determine the degree of importance of the scene based on the shot image in accordance with the degree-of-importance determination rule information 31. The degree-of-importance determination rule information 31 may be included in the smartphone 1 in advance at shipping or may be set optionally by the user later. In a second usable method, an image is input, and a trained neural network built up to output the degree of importance of a scene included in the image is applied to the determination unit 21. The determination unit 21 to which the neural network is applied is acquired, for example, by machine learning using large volume training data having pairs of images and the respective degrees of importance of the scenes. Even if the degree-of-importance determination rule information 31 is not set, the determination unit 21 acquired by the machine learning in this manner may use an image shot by the first camera 11 as input and thus may output the degree of importance of a scene included in the image. The machine learning may be performed by using training data prepared in advance by the manufacturer before shipping or by using training data prepared by the user after shipping. In the latter case, the determination unit 21 that determines the degree of importance more suitably to meet the taste of the user may be acquired.

Further, the camera controller 22 controls the operation mode of the second camera 12 based on the degree of importance of the scene determined by the determination unit 21. In an example in this embodiment, based on the degree of importance of the scene, the camera controller 22 performs switching of the operation mode of the second camera 12 between the shooting mode in which the shooting operation is performed and the low power consumption mode in which the power consumption is lower than the power consumption in the shooting operation.

According to the configuration described above, the operation mode of the second camera 12 is switched to the low power consumption mode based on the degree of importance of a scene for the shooting operation, an undesirable event in which the second camera 12 shoots a scene having a low degree of importance and power is wasted is avoided.

More specifically, if the degree of importance determined by the determination unit 21 indicates high importance of the scene for the shooting operation, the camera controller 22 causes the second camera 12 to operate in the shooting mode. If the determined degree of importance indicates low importance of the scene, the camera controller 22 causes the second camera 12 to operate in the low power consumption mode.

According to the configuration described above, switching of the operation mode of the second camera 12 is performed based on the degree of importance of the scene for the shooting operation. The second camera 12 is thus caused to perform a shooting operation for a scene having a high degree of importance and caused to operate in the low power consumption mode for a scene having a low degree of importance, and power consumption is reduced. As the result, an image of a scene having a high degree of importance is acquired from the second camera 12 with the power consumption being reduced.

Upon deciding the operation mode to be used by the second camera 12 based on the degree of importance of the scene, the camera controller 22 controls the second camera 12 in accordance with the definition of the decided operation mode by referring to the mode definition information 33. Specifically, if the operation mode of the second camera 12 is switched to the shooting mode, the camera controller 22 controls the second camera 12 to perform an operation defined as the operation in the shooting mode in the mode definition information 33. If the operation mode of the second camera 12 is switched to the low power consumption mode, the camera controller 22 controls the second camera 12 to perform an operation defined as the operation in the low power consumption mode in the mode definition information 33.

### Specific Example

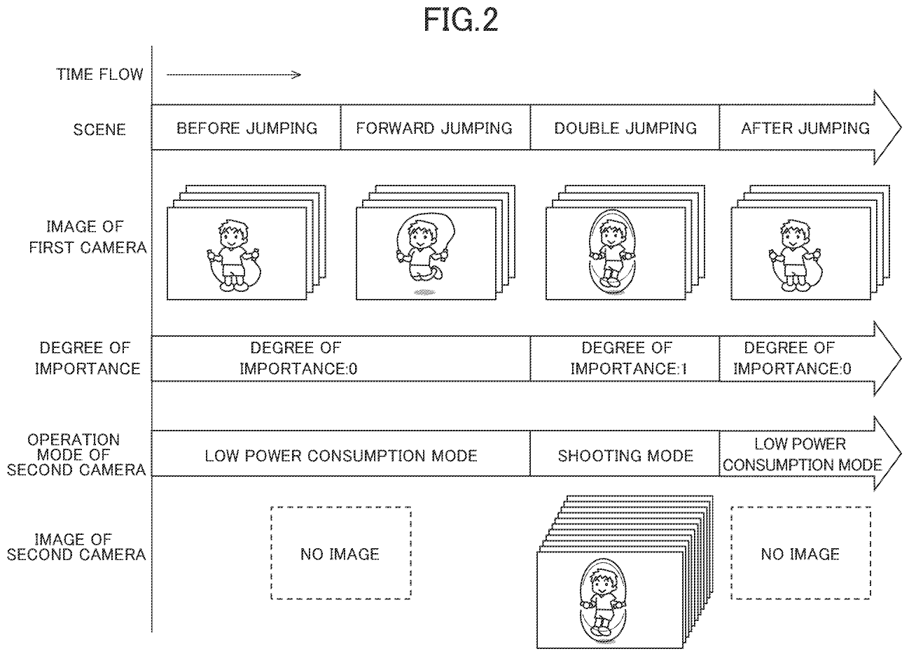

FIG. 2 is a timing chart illustrating scenes for a shooting operation and the operation of the smartphone 1 according to Embodiment 1 in a time series.

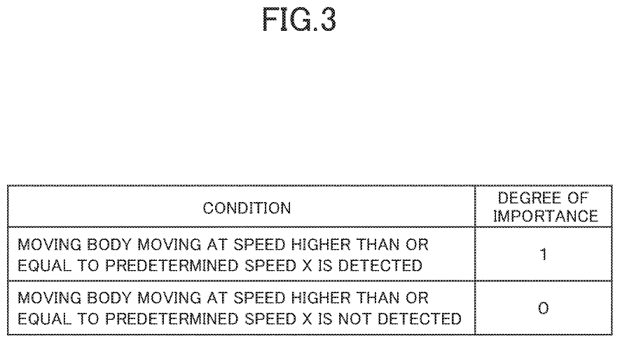

In this specific example, for example, scenes where a child jumps rope are shot. In this specific example, the degree-of-importance determination rule information 31 is set in advance to have the details illustrated in FIG. 3 as to be described later. The degree of importance is binary data indicating a value of 0 or 1 in this specific example, and thus an operation for setting the degree-of-importance threshold information 32 may be omitted.

In this specific example, for example, the mode definition information 33 defines the shooting mode of the second camera 12 as a mode in which slow shooting is performed at a frame rate higher than the frame rate of the first camera 11. The mode definition information 33 may include information concretely designating a frame rate in the slow shooting. The mode definition information 33 also defines, for example, the low power consumption mode of the second camera 12 as a mode in which a waiting operation is performed in a standby state. The standby state means a state where the second camera 12 does not perform a shooting operation and receives low current supply. That is, the second camera 12 in the standby state does not acquire a shot image but has considerably reduced power consumption as compared with the power consumption of the second camera 12 operating in the shooting mode. Specifically, the standby state has some patterns depending on which one of the electronic components of the second camera 12 receives a signal or current and how the signal or current is supplied. The patterns of the standby state are described in detail later.

### Low Power Consumption Mode

As described above, the low power consumption mode denotes the operation mode in which the second camera 12 performs an operation having power consumption lower than the power consumption in the shooting operation in the shooting mode. The details of the operation of the second camera 12 in the low power consumption mode are defined by the mode definition information 33 together with the details of the operation of the second camera 12 in the shooting mode. Hereinafter, the patterns of the standby state will be described.

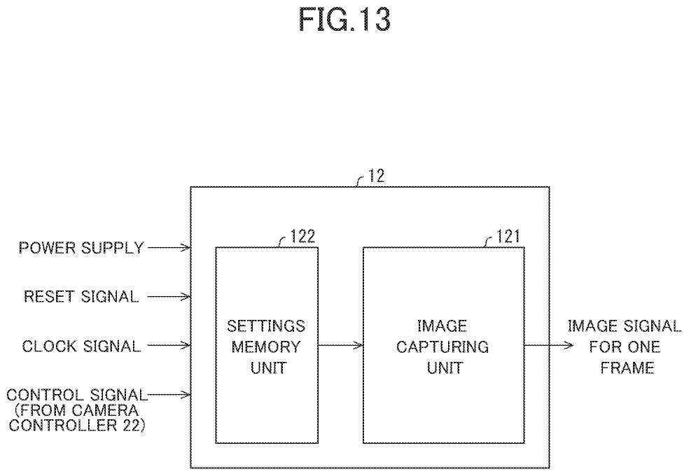

FIG. 13 is a schematic block diagram illustrating the configuration of principal components of the second camera 12. The second camera 12 includes an image capturing unit 121 and a settings memory unit 122. The image capturing unit 121 is a shooting mechanism having various components for shooting and includes, for example, a lens, a lens drive unit, a diaphragm, a diaphragm drive unit, an imaging device, a signal amplifier, an analog-to-digital converter, an image signal output controller, a buffer, and other components. A large amount of power is consumed to drive these various components to shoot an image.

The settings memory unit 122 temporarily stores information regarding various settings that defines the details of the operations of the image capturing unit 121. The settings memory unit 122 is capable of storing set values as long as power is supplied. The settings memory unit 122 consumes power lower than the power consumed while the image capturing unit 121 is operating.

Performing the shooting operation by the second camera 12 entails driving of both of the image capturing unit 121 and thus the settings memory unit 122, and both the image capturing unit 121 and the settings memory unit 122 consume power. Not performing the shooting operation by the second camera 12 also entails continuance of power supply to the settings memory unit 122 to hold a set value, but the image capturing unit 121 may be stopped. Stopping the image capturing unit 121 leads to considerable reduction in the power consumption of the second camera 12.

In this embodiment, the low power consumption mode is implemented as the standby state by stopping at least the image capturing unit 121. In an example, the following four patterns of the standby state are assumed.

### Pattern 1: Turning Off the Second Camera 12

In Pattern 1 of the standby state, power supply to the second camera 12 is stopped. In this case, input of a control signal directing the start of shooting from the camera controller 22 of the controller device 10 involves an operation for reading out settings information from the nonvolatile memory such as the memory unit 13 and then writing the settings information to the settings memory unit 122. A shooting activation period from the direction from the camera controller 22 to start shooting to the start of the shooting by the image capturing unit 121 is made longer than the other patterns by a time period taken for this operation. However, power supply to the second camera 12 is stopped, and thus causing the second camera 12 to enter the standby state in Pattern 1 leads to the lowest power consumption of the four patterns.

### Pattern 2: Stopping the Driving of the Image Capturing Unit 121 and Clock Signal Supply and Performing a Reset Operation

In Pattern 2 of the standby state, power is supplied to the second camera 12; however, the driving the image capturing unit 121 and clock signal supply are stopped, and a reset state is kept. The power consumption is higher than that in Pattern 1 but is reduced by the power consumption corresponding to the non-supply of the clock signal. In addition, there is no need for an operation for initializing the state of the image capturing unit 121 at the turning on unlike Pattern 1, and thus the shooting activation period is made shorter than in Pattern 1 by a time period taken for this operation.

### Pattern 3: Supplying Power and a Clock Signal, Cancelling a Reset State, and Stopping the Driving of the Image Capturing Unit 121

In Pattern 3 of the standby state, power is supplied to the second camera 12, the clock signal supply continues, and a reset state is cancelled. In Pattern 3, the camera controller 22 holds settings information in the settings memory unit 122 by using a control signal, while the image capturing unit 121 remains in the stopped state.

Since power is supplied to the settings memory unit 122 to keep the settings information in the settings memory unit 122, the power consumption is higher than that in Pattern 2. However, the continued power supply during the standby state in Pattern 3 causes the settings information to be held in the settings memory unit 122, and thus there is no need for the operation for reading out the settings information from the nonvolatile memory and writing the settings information to the settings memory unit 122. Accordingly, the shooting activation period may be made further shorter than in Pattern 2.

### Pattern 4: Supplying Power, Cancelling a Reset State, and Stopping Clock Signal Supply and the Driving of the Image Capturing Unit 121

In Pattern 4 of the standby state, power is supplied to the second camera 12, clock signal supply continues, and the resetting is cancelled. In Pattern 4, the camera controller 22 holds the settings information in the settings memory unit 122 by using a control signal, causes the image capturing unit 121 to remain in the stopped state, and stops a clock signal.

Although the image capturing unit 121 does not perform a shooting operation, even the clock signal supply consumes power. Accordingly, stopping the clock signal makes the power consumption lower than in Pattern 3 by power consumption for the clock signal supply. Also in Pattern 4 like Pattern 3, the settings information is held in the settings memory unit 122, and thus there is no need for the operation for reading out the settings information from the nonvolatile memory and writing the settings information to the settings memory unit 122. Accordingly, also in Pattern 4 like Pattern 3, the shooting activation period is made further shorter than in Pattern 2.

As described above, the camera controller 22 causes the second camera 12 to enter the standby state that is an example of the low power consumption mode, and thereby the power consumption is considerably reduced as compared with the case where the second camera 12 performs the shooting operation in the shooting mode. To select one of the above-described patterns of the standby state, the pattern may be appropriately decided in consideration of the shooting activation period having an offset relationship with the power consumption, the purpose for installing the second camera 12, and the like.

The low power consumption mode is not limited to the standby state where shooting is not performed. In another example, the shooting mode is the mode in which slow shooting is performed at a frame rate higher than the frame rate of the first camera 11, while the low power consumption mode may be a mode in which a low-power shooting operation having power consumption lower than in a shooting operation in the shooting mode is performed.

Reducing the resolutions or the image size of a shot image or the frame rate of a moving image enables reduction in the power consumption of the image capturing unit 121 in the shooting operation. The camera controller 22 thus may control the second camera 12 in such a manner that the low-power shooting operation is performed in the low power consumption mode, for example, resolutions or an image size, or a frame rate is made lower than that in the shooting mode.

According to the configuration described above, the second camera 12 shoots scenes constantly, while the second camera 12 performs a low-power shooting operation providing a low-quality image in an unimportant scene. The second camera 12 performs an ordinary shooting operation providing a high quality image in only an important scene. This leads to power consumption lower than the power consumption in the case where a plurality of cameras constantly perform the shooting operation providing a high-quality image. Further, the second camera 12 does not enter the standby state, and thus missing shooting an intended scene by the second camera 12 is avoided.

### Data Structure

FIG. 3 is a table illustrating an example data structure of the degree-of-importance determination rule information 31 stored in the memory unit 13 of the smartphone 1 according to Embodiment 1. The degree-of-importance determination rule information 31 includes respective items of, for example, a condition and the degree of importance.

The condition item stores the feature of an image shot by the first camera 11 as a condition for determining the degree of importance. The degree-of-importance item stores the degree of importance to be applied to a scene included in the image described above when the condition in the condition item is satisfied.

When the feature stored in the condition item is identified in the image shot by the first camera 11, the determination unit 21 determines that the image satisfies the condition defined in the condition item. The determination unit 21 outputs a value stored in the degree-of-importance item associated with the condition, as the degree of importance of the scene included in the image.

Specifically, based on the degree-of-importance determination rule information 31 illustrated in FIG. 3, the determination unit 21 first determines whether a moving body moving at a speed higher than or equal to a predetermined speed X is present in the moving image being currently shot by the first camera 11. If the determination unit 21 detects the moving body moving at a speed higher than or equal to the predetermined speed X in the moving image, the determination unit 21 determines the degree of importance of the scene included in the moving image as “1” in accordance with the degree-of-importance determination rule information 31 illustrated in FIG. 3. If the determination unit 21 does not detect the moving body moving at a speed higher than or equal to the predetermined speed X in the moving image, the determination unit 21 determines the degree of importance of the scene as “0” in accordance with the degree-of-importance determination rule information 31.

The following describes more details based on the specific example illustrated in FIG. 2. In the first phase “before jumping” before the child jumps rope, the first camera 11 shoots a moving image including a scene where the child prepares for jumping. In this moving image, the determination unit 21 does not detect a moving body rapidly moving at a speed higher than or equal to the predetermined speed X. In this case, the determination unit 21 determines the degree of importance of the scene as “0” in accordance with the degree-of-importance determination rule information 31 illustrated in FIG. 3.

In this embodiment, if the degree of importance is determined as “0”, the camera controller 22 causes the second camera 12 to operate in the low power consumption mode. In this embodiment, as described above, the mode definition information 33 defines the low power consumption mode as the mode in which a waiting operation is performed in the standby state. The second camera 12 thus remains in the standby state and does not shoot a moving image for the scene in the first phase “before jumping”.

In the second phase “forward jumping”, a moving image shot by the first camera 11 includes a scene where the child jumps forward. However, the speed of the moving body including the child and the rope still does not reach the predetermined speed X, and thus the determination unit 21 does not detect the moving body rapidly moving at a speed higher than or equal to the predetermined speed X in the moving image. The determination unit 21 thus determines the degree of importance of the scene in the second phase “forward jumping” as “0” in accordance with the degree-of-importance determination rule information 31. Accordingly, the camera controller 22 keeps the low power consumption mode of the second camera 12, and thus the second camera 12 does not shoot a moving image in this phase, either.

In the third phase “double jumping”, a moving image shot by the first camera 11 includes a scene where the child double-jumps. The speed of the rope reaches the predetermined speed X or higher, and the determination unit 21 detects a moving body rapidly moving at a speed higher than or equal to the predetermined speed X in this moving image. In this case, the determination unit 21 determines the degree of importance of the scene in the third phase “double jumping” as “1” in accordance with the degree-of-importance determination rule information 31.

In this embodiment, if the degree of importance is determined as “1”, the camera controller 22 causes the second camera 12 to operate in the shooting mode. In this embodiment, as described above, the mode definition information 33 defines the shooting mode as the mode in which slow shooting is performed at a frame rate higher than the frame rate of the first camera 11. The second camera 12 thus performs a shooting operation and shoots a slow moving image for the scene in the third phase “double jumping”.

In the fourth phase “after jumping”, like the first and second phases, the determination unit 21 does not detect a moving body rapidly moving at a speed higher than or equal to the predetermined speed X in the moving image of the first camera 11. Accordingly, the degree of importance is determined as “0”, and the second camera 12 does not shoot a moving image.

### Processing Flow

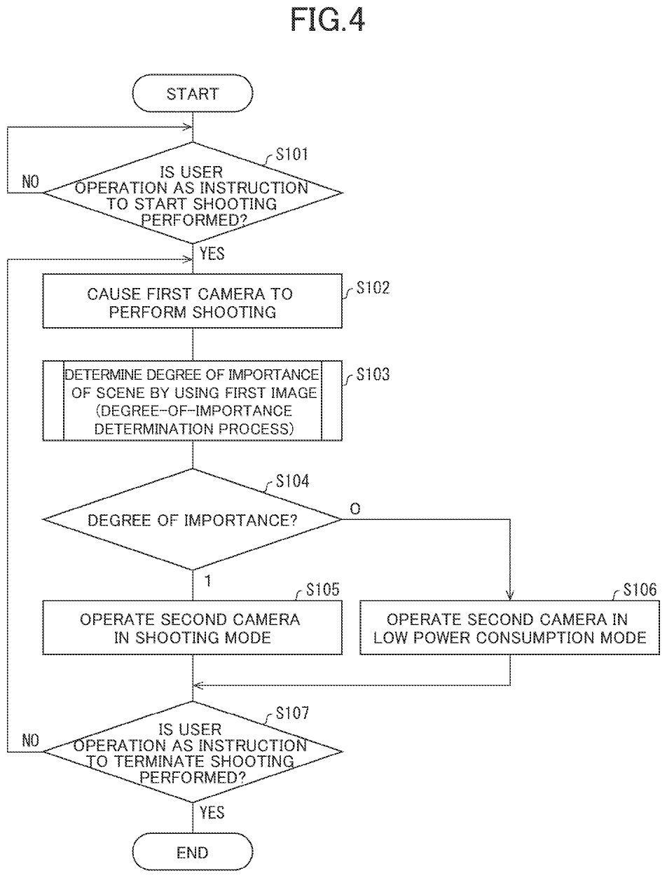

FIG. 4 is a flowchart illustrating an example flow of a process executed by the controller device 10 of the smartphone 1 according to Embodiment 1.

In step S101, the camera controller 22 receives a user operation serving as an instruction to start shooting. The user operation is input by using the operation unit 14. Upon receiving the user operation, the camera controller 22 proceeds from YES in step S101 to step S102.

In step S102, the camera controller 22 controls the first camera 11 in accordance with the user operation. The first camera 11 performs the shooting operation under the control of the camera controller 22 and generates an image of a scene for the shooting operation.

In step S103 (a determination process and determining), the determination unit 21 executes a degree-of-importance determination process for determining the degree of importance of the scene by using the image (hereinafter, a first image) acquired from the first camera 11 by the shooting in step S102.

In step S104, the camera controller 22 refers to the degree of importance determined in step S103. If the degree of importance indicates “1”, the camera controller 22 proceeds to step S105. If the degree of importance indicates “0”, the camera controller 22 proceeds to step S106.

In step S105 (a camera control process and camera controlling), the camera controller 22 causes the second camera 12 to operate in the shooting mode. The second camera 12 performs the shooting operation in accordance with the instruction from the camera controller 22. In an example, the second camera 12 may perform slow shooting of the scene.

In step S106 (the camera control process and the camera controlling), the camera controller 22 causes the second camera 12 to operate in the low power consumption mode. The second camera 12 operates in the low power consumption mode in accordance with the instruction from the camera controller 22. In an example, the second camera 12 may remain in the standby state.

In step S107, the camera controller 22 receives a user operation as an instruction to terminate the shooting via the operation unit 14. Upon receiving the user operation, the camera controller 22 proceeds to YES in step S107 and terminates the series of steps related to the shooting by the first camera 11 and the second camera 12. Before receiving the user operation, the camera controller 22 returns from NO in step S107 to step S102. The succeeding steps are then repeated.

### Degree-Of-Importance Determination Process

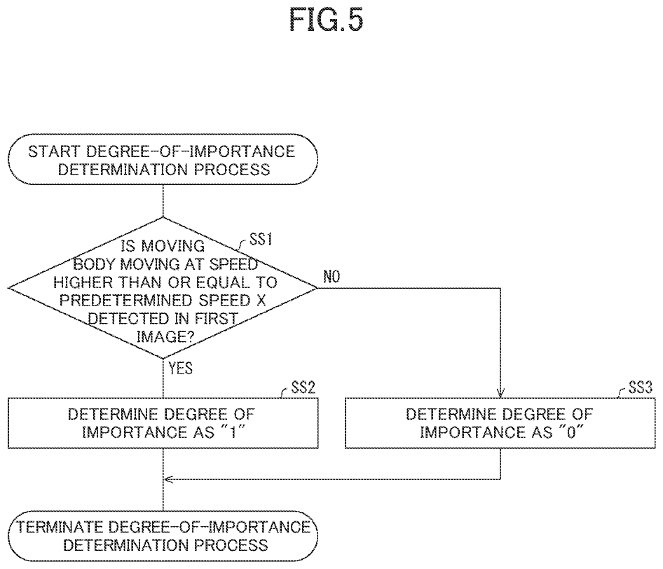

FIG. 5 is a flowchart illustrating an example flow of the degree-of-importance determination process executed by the determination unit 21 of the controller device 10 according to Embodiment 1. The series of steps illustrated in FIG. 5 corresponds to step S103 illustrated in FIG. 4.

In step SS1, the determination unit 21 determines whether a moving body moving at a speed higher than or equal to the predetermined speed X is present in the first image generated by the first camera 11 in step S102. If the determination unit 21 detects the moving body moving at a speed higher than or equal to the predetermined speed X in the first image, the determination unit 21 proceeds from YES in step SS1 to step SS2. If the determination unit 21 does not detect the moving body moving at a speed higher than or equal to the predetermined speed X in the first image, the determination unit 21 proceeds from NO in step SS1 to step SS3.

In step SS2, the determination unit 21 determines the degree of importance of the scene included in the first image as “1” based on the degree-of-importance determination rule information 31 stored in the memory unit 13.

In step SS3, the determination unit 21 determines the degree of importance of the scene included in the first image as “0” based on the degree-of-importance determination rule information 31 stored in the memory unit 13.

The determination unit 21 stores the degree of importance determined in step SS2 or SS3 in the buffer (not illustrated) to enable the camera controller 22 to refer to the degree of importance and then terminates the series of steps in the degree-of-importance determination process.

In another example in this embodiment, the determination unit 21 may evaluate the degree of importance of the scene by using a multi-level value. For example, the determination unit 21 may evaluate the degree of importance based on the speed of the motion of a moving body included in the moving image shot by the first camera 11 on a scale of one to three, one to five, or the like or on a maximum of 10 points, 100 points, or the like. In this case, one threshold is set as the degree-of-importance threshold information 32 for determining whether to cause the second camera 12 to enter the shooting mode based on the degree of importance. The camera controller 22 compares the degree of importance having the multi-level value output by the determination unit 21 with the degree-of-importance threshold information 32. For example, if the output degree of importance is lower than the threshold as the degree-of-importance threshold information 32, the camera controller 22 causes the second camera 12 to operate in the low power consumption mode. If the output degree of importance is higher than or equal to the threshold as the degree-of-importance threshold information 32, the camera controller 22 causes the second camera 12 to operate in the shooting mode.

As described above, in the controller device 10 of the smartphone 1 according to Embodiment 1, the determination unit 21 decides the degree of importance of a scene where a moving body moving at a speed higher than or equal to the predetermined speed X is detected in the image shot by the first camera 11 such that the degree of importance is higher than the degree of importance of a scene where a moving body moving at a speed lower than the predetermined speed X is detected or where no moving body is detected.

According to the configuration and the method that are described above, power consumption is reduced, and the image of an important scene where a moving body moving at a speed higher than or equal to a predetermined speed is included in the image of the first camera 11 is acquired also from the second camera 12.

### Embodiment 2

Hereinafter, another embodiment of the present disclosure will be described. For convenience of explanation, members having the same functions as those of members described for the aforementioned embodiment are denoted by the same references, and description thereof is not repeated.

### Specific Example

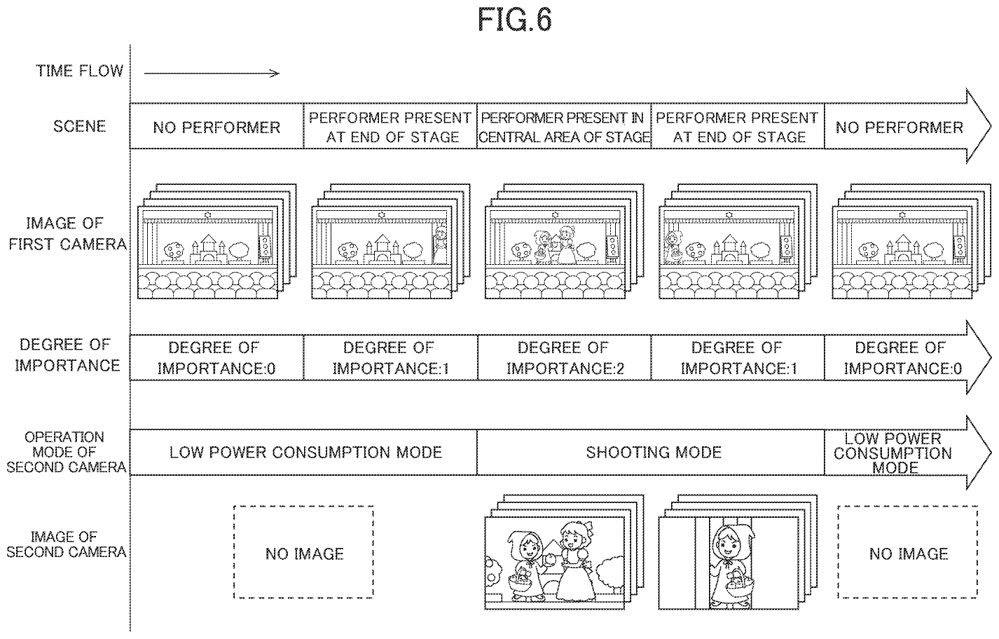

FIG. 6 is a timing chart illustrating scenes for a shooting operation and the operation of the smartphone 1 according to Embodiment 2 in a time series.

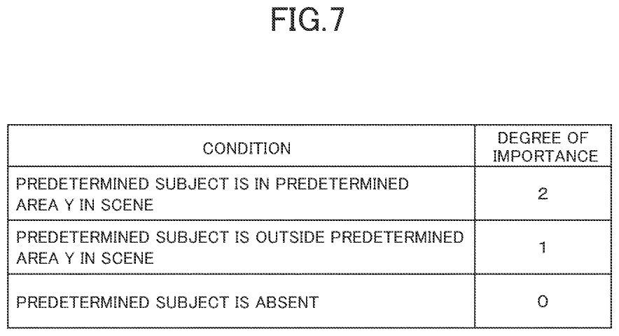

In this specific example, for example, scenes where one or more performers play on the stage in a drama are shot. In this specific example, the degree-of-importance determination rule information 31 having the content illustrated in FIG. 7 is set in advance (described later). In this specific example, the degree of importance is indicated by a multi-level value on a scale of one to three or more. In an example, the degree of importance is determined on a scale of one to three, indicating one of the values “0”, “1”, and “2”. In this specific example, a higher value of the degree of importance denotes higher importance of a scene.

In this embodiment, the degree-of-importance threshold information 32 has two thresholds. Specifically, the degree-of-importance threshold information 32 has an on threshold and an off threshold. The on threshold (a first threshold) serves as a criterion for causing the second camera 12 to enter the shooting mode. For example, when the degree of importance changes from a value lower than the on threshold to a value higher than or equal to the on threshold, the camera controller 22 may perform switching of the second camera 12 to the shooting mode. In this specific example, for example, the on threshold of the degree of importance is set at “2”.

The off threshold (a second threshold) serves as a criterion for causing the second camera 12 to enter the low power consumption mode. The off threshold is set lower than the on threshold. For example, when the degree of importance changes from a value higher than or equal to the off threshold to a value lower than the off threshold, the camera controller 22 may perform switching of the second camera 12 to the low power consumption mode. In this specific example, for example, the off threshold of the degree of importance is set at “1”.

It is assumed that when the degree of importance of a scene is determined in binary indicating importance and unimportance, the degree of importance changes between the two values at short intervals as the scene changes. Switching the mode of the second camera 12 in response to a change of the degree of importance leads to short-interval repetition of operations of the second camera 12 for performing shooting and not performing shooting.

Hence, the on threshold and the off threshold are provided. The on threshold is used for performing switching from the low power consumption mode to the shooting mode. The off threshold is lower than the on threshold and serves as a threshold for performing switching from the shooting mode to the low power consumption mode. A change only to the value lower than the on threshold thus does not lead to immediate switching to the low power consumption mode. Further, until the degree of importance reaches a value lower than the off threshold, the shooting mode is kept. Only after a change to a value lower than the off threshold, switching to the low power consumption mode is performed. In contrast, regarding switching from the low power consumption mode to the shooting mode, even if the degree of importance reaches a value higher than or equal to the off threshold, the low power consumption mode is kept until a change to the on threshold higher than the value. Only when the degree of importance becomes higher than or equal to the on threshold, switching to the shooting mode is performed. As the result, frequent switching of the mode of the second camera 12 is avoided.

In this specific example, for example, the mode definition information 33 defines the shooting mode of the second camera 12 as a mode in which a full shot (full-length shot) of a performer is taken in a closer shot than a shot by the first camera 11. The mode definition information 33 may include model data regarding a subject (predetermined subject) to be captured in the angle of view in the shooting mode. The model data may be a photograph of the subject or may be feature data extracted from the photograph of the subject. The mode definition information 33 also defines the low power consumption mode of the second camera 12, for example, as the mode in which a waiting operation is performed in the standby state.

The smartphone 1 may present, on the display unit (not illustrated), a user interface for assisting the user in optionally setting the degree-of-importance determination rule information 31, the degree-of-importance threshold information 32, and the mode definition information 33 that are described above.

### Data Structure

FIG. 7 is a table illustrating an example data structure of the degree-of-importance determination rule information 31 stored in the memory unit 13 of the smartphone 1 according to Embodiment 2. Like Embodiment 1, the degree-of-importance determination rule information 31 includes the condition item and the degree-of-importance item.

Specifically, in accordance with the degree-of-importance determination rule information 31 illustrated in FIG. 7, the determination unit 21 first determines whether the predetermined subject is present in a predetermined range Y in the scene for the shooting operation in the moving image being currently shot by the first camera 11.

The predetermined subject is set in advance in the smartphone 1 as a subject to be shot in the shooting mode. In this specific example, for example, a person is set as the predetermined subject. The determination unit 21 regards a performer on the stage as a person and recognizes the person as the predetermined subject. A publicly known technique may be appropriately used for an image recognition process in which the determination unit 21 detects a specific object in the image. The predetermined subject may be optionally selected by the user by using the operation unit 14.

The predetermined range Y is set, for example, as “the central area of the stage” in this specific example. For example, the determination unit 21 identifies the center of the stage based on the feature points identified from the screen, the background, or the like on the stage in the image and identifies an area within a predetermined distance from the center as the predetermined range Y, that is, “the central area of the stage”. The predetermined range Y may be optionally set by the user by using the operation unit 14.

If the determination unit 21 determines that the predetermined subject is present in the predetermined range Y in the scene in the moving image described above, the determination unit 21 determines the degree of importance of the scene included in the moving image as “2” in accordance with the degree-of-importance determination rule information 31 illustrated in FIG. 7. If the determination unit 21 determines that the predetermined subject is present outside the predetermined range Y in the scene in the moving image, the determination unit 21 determines the degree of importance of the scene as “1” in accordance with the degree-of-importance determination rule information 31. If the determination unit 21 determines that the predetermined subject is not present in the moving image, the determination unit 21 determines the degree of importance of the scene as “0” in accordance with the degree-of-importance determination rule information 31.

Specifically, in this specific example, the determination unit 21 determines a scene where a performer is present in the central area of the stage to be most important, a scene where a performer is not present in the central area but is present on the stage to be second most important, and a scene where there is no performer on the stage to be least important.

The following describes more details based on the specific example illustrated in FIG. 6. In the first phase “no performer” where there is no performer on the stage, the first camera 11 shoots a moving image including a scene where there is no performer on the stage. The determination unit 21 determines that there is no performer on the stage in the moving image. In this case, the determination unit 21 determines the degree of importance of the scene in the first phase “no performer” as “0” in accordance with the degree-of-importance determination rule information 31 illustrated in FIG. 7.

In this embodiment, based on the state where the current operation mode of the second camera 12 is the low power consumption mode, that is, the second camera 12 is not performing the shooting operation, the camera controller 22 compares the determined degree of importance with the on threshold. Specifically, the camera controller 22 determines that the determined degree of importance “0” is lower than the on threshold “2”. In this case, the camera controller 22 keeps the low power consumption mode of the second camera 12. In this embodiment, as described above, the mode definition information 33 defines the low power consumption mode as the mode in which a waiting operation is performed in the standby state. Accordingly, the second camera 12 remains in the standby state and does not shoot a moving image for the scene in the first phase “no performer”.

In the second phase “performer present at end of stage”, a moving image shot by the first camera 11 includes a scene where a performer appears at an end of the stage. However, any performer is not present in the central area of the stage. In the moving image, the determination unit 21 detects a performer in a location other than the central area of the stage. Accordingly, the determination unit 21 determines the degree of importance of the scene in the second phase “performer present at end of stage” as “1” in accordance with the degree-of-importance determination rule information 31.

Based on the state where the second camera 12 is not performing a shooting operation, the camera controller 22 compares the determined degree of importance with the on threshold. Specifically, the camera controller 22 determines that the determined degree of importance “1” is still lower than the on threshold “2”. The camera controller 22 keeps the standby state of the second camera 12. Accordingly, the second camera 12 still does not shoot a moving image for the scene in the second phase “performer present at end of stage”.

In the third phase “performer present in central area of stage”, a moving image shot by the first camera 11 includes a scene where at least one performer moves to the central area of the stage. The determination unit 21 detects one or more performers in the central area of the stage in the moving image. Accordingly, in accordance with the degree-of-importance determination rule information 31, the determination unit 21 determines the degree of importance as “2” for the scene in the third phase “performer present in central area of stage”.

Based on the state where the second camera 12 is not performing a shooting operation, the camera controller 22 compares the determined degree of importance with the on threshold. Specifically, the camera controller 22 determines that the determined degree of importance “2” is higher than or equal to the on threshold “2”. The camera controller 22 then performs switching of the operation mode of the second camera 12 from the low power consumption mode to the operation mode. The second camera 12 thus starts shooting a moving image for the scene in the third phase “performer present in central area of stage”. In this specific example, as described above, the mode definition information 33 defines the shooting mode as the mode in which a full shot of a performer is taken in a closer shot than a shot by the first camera 11. The second camera 12 thus performs a zoom shooting operation under the control of the camera controller 22 to shoot a full-length image of the performers in the central area of the stage.

In the fourth phase “performer present at end of stage”, a moving image shot by the first camera 11 includes a scene where all the performers have left the central area of the stage and absent there again. In this specific example, one of the performers hides in the wing of the stage, and the other performer moves to an end of the stage. There is no performer in the central area of the stage. The determination unit 21 detects the performer in a location other than the central area of the stage in the moving image. Accordingly, the determination unit 21 determines the degree of importance of the scene in the fourth phase “performer present at end of stage” as “1” in accordance with the degree-of-importance determination rule information 31.

Based on the state where the second camera 12 is performing a shooting operation, the camera controller 22 compares the determined degree of importance with the off threshold. Specifically, the camera controller 22 determines that the determined degree of importance “1” is higher than or equal to the off threshold “1”. The camera controller 22 keeps the shooting mode of the second camera 12. Accordingly, the second camera 12 still performs the zoom shooting for a full shot of the performer for the scene in the fourth phase “performer present at end of stage”.

In the fifth phase “no performer”, a moving image shot by the first camera 11 includes a scene where all the performers hide in the wing of the stage. The determination unit 21 determines that there is no performer on the stage in the moving image. In this case, the determination unit 21 determines the degree of importance of the scene in the fifth phase “no performer” as “0” in accordance with the degree-of-importance determination rule information 31.

Based on the state where the second camera 12 is performing a shooting operation, the camera controller 22 compares the determined degree of importance with the off threshold. Specifically, the camera controller 22 determines that the determined degree of importance “0” is lower than the off threshold “1”. The camera controller 22 then performs switching of the operation mode of the second camera 12 from the shooting mode to the low power consumption mode. The second camera 12 thus does not shoot a moving image for the scene in the fifth phase “no performer”.

### Processing Flow

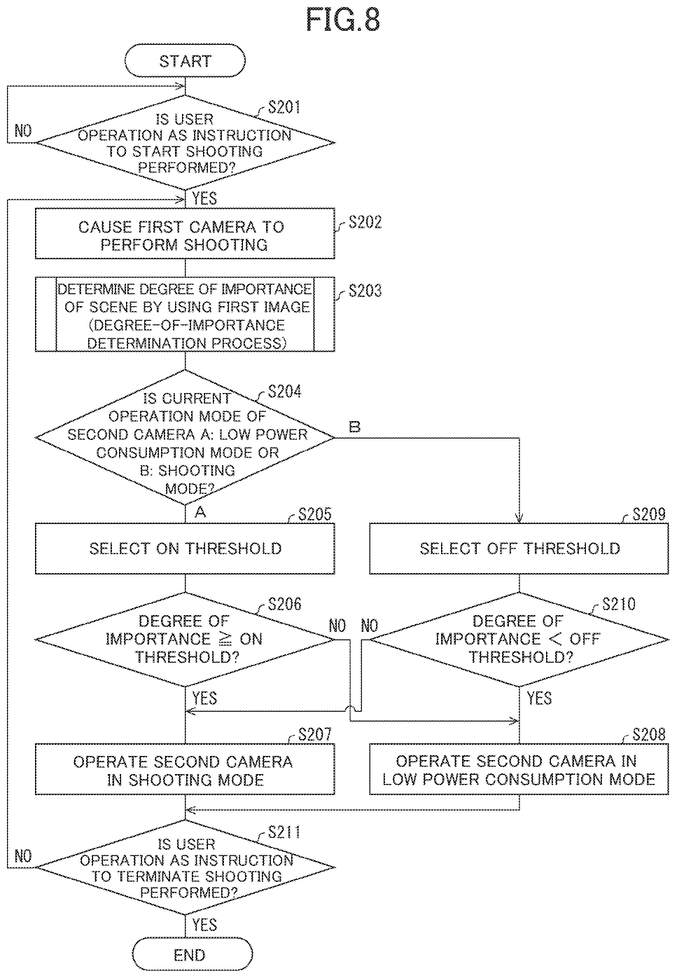

FIG. 8 is a flowchart illustrating an example flow of a process executed by the controller device 10 of the smartphone 1 according to Embodiment 2.

In step S201, the camera controller 22 receives a user operation serving as an instruction to start shooting. The user operation is input by using the operation unit 14. Upon receiving the user operation, the camera controller 22 proceeds from YES in step S201 to step S202.

In step S202, the camera controller 22 controls the first camera 11 in accordance with the user operation. The first camera 11 performs the shooting operation under the control of the camera controller 22 and generates an image of a scene for the shooting operation.

In step S203 (a determination process and determining), the determination unit 21 executes a degree-of-importance determination process for determining the degree of importance of the scene by using the first image acquired from the first camera 11 by the shooting in step S202.

In step S204, in accordance with the current operation mode of the second camera 12, the camera controller 22 selects one of the thresholds in the degree-of-importance threshold information 32 for making a comparison with the degree of importance determined in step S203. If the operation mode of the second camera 12 is the low power consumption mode, the camera controller 22 proceeds from A in step S204 to step S205. If the operation mode of the second camera 12 is the shooting mode, the camera controller 22 proceeds from B in step S204 to step S209.

In step S205, the camera controller 22 selects the on threshold as the degree-of-importance threshold information 32 used for the comparison with the degree of importance.

In step S206, the camera controller 22 compares the degree of importance determined in step S203 with the on threshold. If the degree of importance is higher than or equal to the on threshold, the camera controller 22 proceeds from YES in step S206 to step S207. If the degree of importance is lower than the on threshold, the camera controller 22 proceeds from NO in step S206 to step S208.

In step S207 (the camera control process and the camera controlling), the camera controller 22 causes the second camera 12 to operate in the shooting mode. If the camera controller 22 reaches step S207 via A in step S204, the camera controller 22 here performs switching of the operation mode of the second camera 12 from the low power consumption mode to the shooting mode.

In step S208 (the camera control process and the camera controlling), the camera controller 22 causes the second camera 12 to operate in the low power consumption mode. If the camera controller 22 reaches step S208 via A in step S204, the camera controller 22 keeps the low power consumption mode of the second camera 12.

In step S209, the camera controller 22 selects the off threshold as the degree-of-importance threshold information 32 used for making a comparison with the degree of importance.

In step S210, the camera controller 22 compares the degree of importance determined in step S203 with the off threshold. If the degree of importance is higher than or equal to the off threshold, the camera controller 22 proceeds from NO in step S210 to step S207. If the camera controller 22 reaches step S207 via B in step S204, the camera controller 22 keeps the shooting mode of the second camera 12. If the degree of importance is lower than the off threshold, the camera controller 22 proceeds from YES in step S210 to step S208. If the camera controller 22 reaches step S208 via B in step S204, the camera controller 22 here performs switching of the operation mode of the second camera 12 from the shooting mode to the low power consumption mode.

In step S211, the camera controller 22 receives a user operation as an instruction to terminate the shooting via the operation unit 14. Upon receiving the user operation, the camera controller 22 proceeds to YES in step S211 and terminates the series of steps related to the shooting by the first camera 11 and the second camera 12. Unless the user operation is received, the camera controller 22 returns from NO in step S211 to step S202, and subsequent steps are repeated.

### Degree-Of-Importance Determination Process

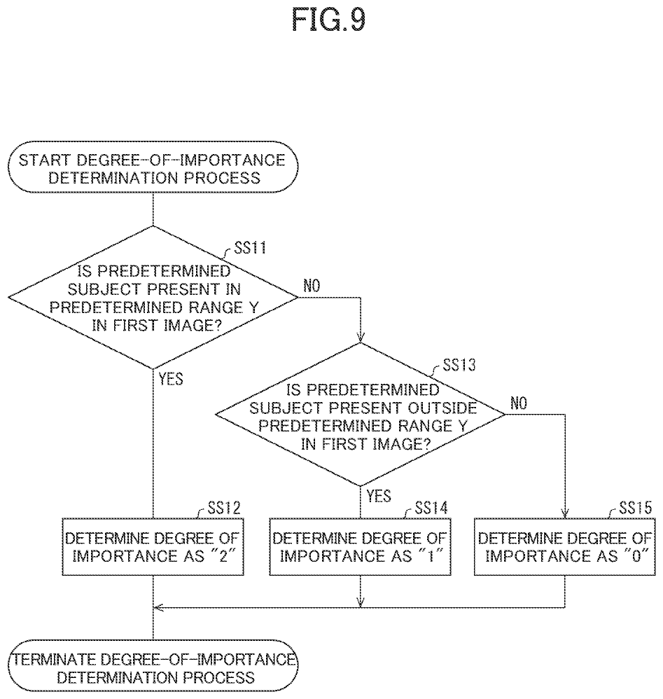

FIG. 9 is a flowchart illustrating an example flow of the degree-of-importance determination process executed by the determination unit 21 of the controller device 10 according to Embodiment 2. The series of steps illustrated in FIG. 9 corresponds to step S203 illustrated in FIG. 8.

In step SS11, the determination unit 21 determines whether the predetermined subject is present in the predetermined range Y in the scene in the first image generated by the first camera 11 in step S202. If the determination unit 21 detects the predetermined subject present in the predetermined range Y in the first image, the determination unit 21 proceeds from YES in step SS11 to step SS12. If the determination unit 21 does not detect the predetermined subject in the predetermined range Y in the first image, the determination unit 21 proceeds from NO in step SS11 to step SS13.

In step SS12, the determination unit 21 determines the degree of importance of the scene included in the first image as “2” based on the degree-of-importance determination rule information 31 stored in the memory unit 13.

In step SS13, the determination unit 21 determines whether the predetermined subject is present outside the predetermined range Y in the first image. If the determination unit 21 detects the predetermined subject outside the predetermined range Y in the first image, the determination unit 21 proceeds from YES in step SS13 to step SS14. If the determination unit 21 does not detect the predetermined subject outside the predetermined range Y, either, in the first image, that is, if the predetermined subject is not included in the first image, the determination unit 21 proceeds from NO in step SS13 to step SS15.

In step SS14, the determination unit 21 determines the degree of importance of the scene included in the first image as “1” based on the degree-of-importance determination rule information 31 stored in the memory unit 13.

In step SS15, the determination unit 21 determines the degree of importance of the scene included in the first image as “0” based on the degree-of-importance determination rule information 31 stored in the memory unit 13.

The determination unit 21 stores the degree of importance determined in step SS12, SS14, or SS15 in the buffer (not illustrated) to enable the camera controller 22 to refer to the degree of importance and terminates the series of steps in the degree-of-importance determination process.

As described above, in the controller device 10 of the smartphone 1 according to Embodiment 2, if the predetermined subject (performer) is present in the predetermined range Y (the central area of the stage) in the scene in the image shot by the first camera 11, the determination unit 21 decides a value higher than or equal to the on threshold (for example, 2) as the degree of importance of the scene. If the predetermined subject is not present in the image, the determination unit 21 decides a value lower than the off threshold (for example, 0) as the degree of importance of the scene. If the predetermined subject is present outside the predetermined range Y in the image, the determination unit 21 decides a value that is higher than or equal to the off threshold and that is lower than the on threshold (for example, 1) as the degree of importance of the scene.

According to the configuration and the method that are described above, the power consumption is reduced, the image of an important scene where the subject is present in the predetermined range is acquired also from the second camera 12. In addition, even if the subject repeats entering and leaving the predetermined range at short intervals, frequent switching between performing and not performing the shooting operation of the second camera 12 is avoided.

### Embodiment 3

Hereinafter, another embodiment of the present disclosure will be described. For convenience of explanation, members having the same functions as those of members described for the aforementioned embodiment are denoted by the same references, and description thereof is not repeated.

### Specific Example

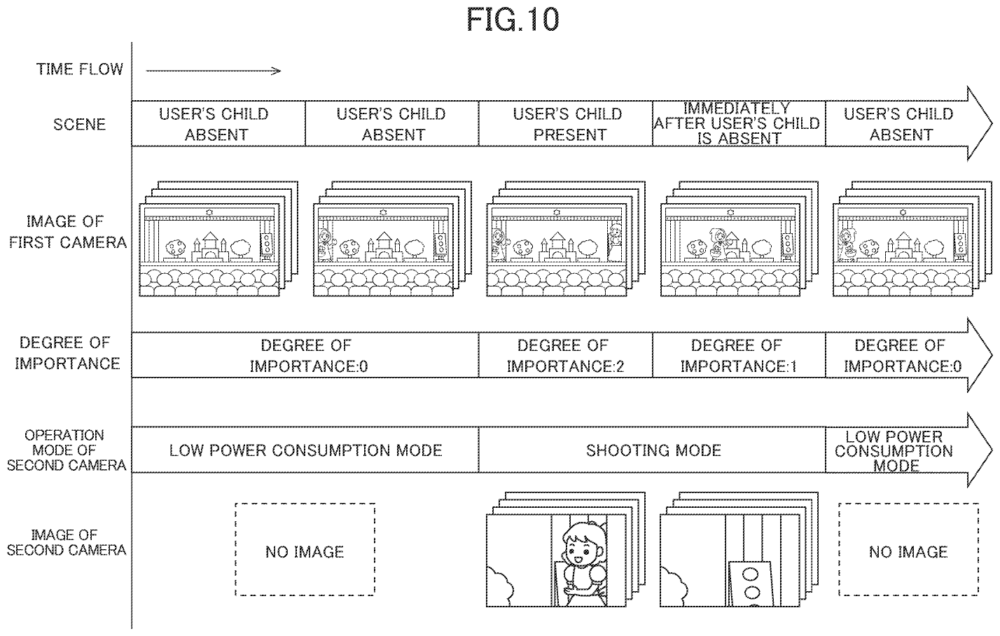

FIG. 10 is a timing chart illustrating scenes for a shooting operation and the operation of the smartphone 1 according to Embodiment 3 in a time series.

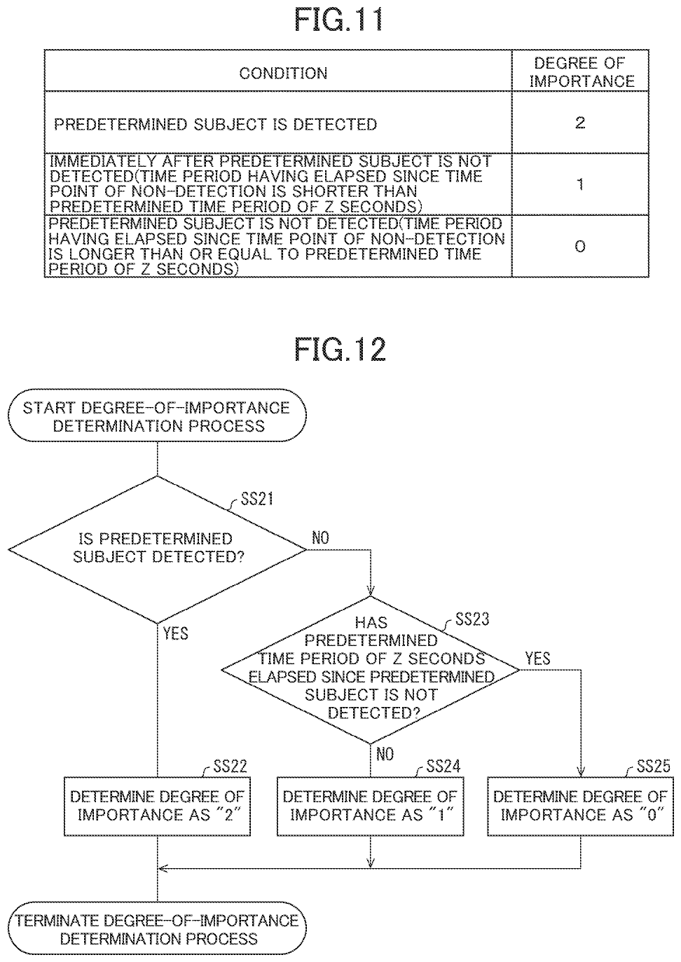

In this specific example, for example, scenes where one or more performers including the user's child play on the stage in a drama are shot. In this specific example, the degree-of-importance determination rule information 31 having the content illustrated in FIG. 11 is set in advance (described later). In this specific example, the degree of importance is indicated by a multi-level value on a scale of one to three or more. In an example, the degree of importance is determined on a scale of one to three, indicating one of the values “0”, “1”, and “2”. In this specific example, a higher value of the degree of importance denotes higher importance of a scene.

In this embodiment, like Embodiment 2, the camera controller 22 decides the operation mode of the second camera 12 by using the on threshold “2” and the off threshold “1” as the degree-of-importance threshold information 32.

In this specific example, the mode definition information 33 defines the shooting mode of the second camera 12, for example, a mode in which zoom shooting is performed to take a waist shot (a shot from the waist up) of the user's child who is the predetermined subject and in which if the user's child leaves, shooting of the place where they have been present is still performed at the same zoom ratio. The mode definition information 33 may include model data regarding the predetermined subject in the shooting mode. In this specific example, for example, the predetermined subject is the user's child. The model data regarding the user's child may be at least one photograph of the user's child registered by the user in advance. Alternatively, the model data regarding the user's child may be feature data regarding the face of the user's child extracted from a plurality of photographs of the user's child registered by the user in advance. Publicly known technology such as face recognition technology may be used appropriately for an individual identification process to be executed by the determination unit 21. In the individual identification process, a specific person is detected in an image.

The smartphone 1 may present, on the display unit (not illustrated), a user interface for assisting the user in optionally setting the degree-of-importance determination rule information 31, the degree-of-importance threshold information 32, and the mode definition information 33 that are described above.

### Data Structure

FIG. 11 is a table illustrating an example data structure of the degree-of-importance determination rule information 31 stored in the memory unit 13 of the smartphone 1 according to Embodiment 3. Like Embodiments 1 and 2, the degree-of-importance determination rule information 31 includes the condition item and the degree-of-importance item.

Specifically, in accordance with the degree-of-importance determination rule information 31 illustrated in FIG. 11, the determination unit 21 first determines whether the predetermined subject is detected in the moving image being currently shot by the first camera 11. In this specific example, the determination unit 21 determines whether the user's child registered in advance is included in the moving image.

If the determination unit 21 detects the predetermined subject in the moving image, the determination unit 21 determines the degree of importance of the scene included in the moving image as “2” in accordance with the degree-of-importance determination rule information 31 illustrated in FIG. 11.

If the determination unit 21 determines that the moving image represents a scene immediately after the predetermined subject is not detected, the determination unit 21 determines the degree of importance of the scene included in the moving image as “1” in accordance with the degree-of-importance determination rule information 31. The moving image immediately after the predetermined subject is not detected denotes a moving image shot in a period in which a time period having elapsed since the predetermined subject is not included in the moving image (hereinafter, a time point of non-detection) is shorter than a predetermined time period of Z seconds. In this specific example, the determination unit 21 determines the degree of importance of the scene included in the moving image as “1” for the moving image shot in the period in which a time period having elapsed since the user's child included in the moving image of the first camera 11 disappears is shorter than the predetermined time period of Z seconds.

If the determination unit 21 determines that the moving image represents a scene where the predetermined subject is not detected, the determination unit 21 determines the degree of importance of the scene included in the moving image as “0” in accordance with the degree-of-importance determination rule information 31. The moving image in which the predetermined subject is not detected denotes a moving image shot after the predetermined time period of Z seconds has elapsed since the time point of non-detection of the predetermined subject. In this specific example, if the predetermined time period of Z seconds has elapsed since the user's child included in the moving image of the first camera 11 disappears, the determination unit 21 determines, as “0”, the degree of importance of the scene included in the moving image shot after the elapse of the predetermined time period of Z seconds.

Specifically, in this specific example, the determination unit 21 determines that the scene where the user's child is present on the stage to be most important, the scene where the user's child leaves the stage but where the period of the absence is shorter than the predetermined time period of Z seconds to be next most important, and the scene where a time period longer than or equal to the predetermined time period of Z seconds has elapsed since the user's child disappears to be least important.

The following describes more details based on the specific example illustrated in FIG. 10. In the first phase “user's child absent” in which the user's child is absent on the stage, the first camera 11 shoots a moving image including the scene where the user's child is absent on the stage. In the moving image, the determination unit 21 determines that the user's child is absent on the stage, that is, the predetermined subject is not detected. In this case, in accordance with the degree-of-importance determination rule information 31 illustrated in FIG. 11, the determination unit 21 determines the degree of importance of the scene in the first phase “user's child absent” as “0”.

In this embodiment, based on a state where the second camera 12 is not performing a shooting operation, the camera controller 22 compares the determined degree of importance with the on threshold. Specifically, the camera controller 22 determines that the determined degree of importance “0” is lower than the on threshold “2”. In this case, the camera controller 22 keeps the low power consumption mode of the second camera 12. In this embodiment, as described above, the mode definition information 33 defines the low power consumption mode as the mode in which a waiting operation is performed in the standby state. Accordingly, the second camera 12 remains in the standby state and does not shoot a moving image of a scene in the first phase “user's child absent”.

In the second phase “user's child absent”, a moving image shot by the first camera 11 includes a scene where a performer other than the user's child appears at an end of the stage. However, the user's child registered as the specific subject is absent on the stage. Like the first phase, the determination unit 21 also determines that the user's child is absent on the stage, that is, the predetermined subject is not detected in the moving image. In this case, the determination unit 21 determines the degree of importance of the scene in the second phase “user's child absent” as “0” in accordance with the degree-of-importance determination rule information 31.

Based on the state where the second camera 12 is not performing a shooting operation, the camera controller 22 compares the determined degree of importance with the on threshold. Specifically, the camera controller 22 determines that the determined degree of importance “0” is still lower than the on threshold “2”. The camera controller 22 keeps the standby state of the second camera 12. Accordingly, the second camera 12 still does not shoot a moving image for the scene in the second phase “user's child absent”.

In the third phase “user's child present”, a moving image shot by the first camera 11 includes a scene where the user's child appears at an end of the stage. The determination unit 21 determines that the user's child is present on the stage, that is, determines that the predetermined subject is detected in the moving image. In this case, the determination unit 21 determines the degree of importance of the scene in the third phase “user's child present” as “2” in accordance with the degree-of-importance determination rule information 31.

Based on the state where the second camera 12 is not performing a shooting operation, the camera controller 22 compares the determined degree of importance with the on threshold. Specifically, the camera controller 22 determines that the determined degree of importance “2” is higher than or equal to the on threshold “2”. The camera controller 22 then performs switching of the operation mode of the second camera 12 from the low power consumption mode to the operation mode. The second camera 12 thus starts shooting a moving image for the scene in the third phase “user's child present”. In this specific example, as described above, the mode definition information 33 defines the shooting mode as the mode in which zoom shooting is performed to take a waist shot of the user's child who is the predetermined subject from the waist up. The second camera 12 thus performs the zoom shooting to shoot an image of the user's child from the waist up under the control of the camera controller 22.

In the fourth phase “immediately after user's child is absent”, a moving image shot by the first camera 11 includes a scene immediately after the user's child leaves the stage. In the moving image, the determination unit 21 measures a time period having elapsed since the user's child leaves the stage. If the elapsed time period is shorter than the predetermined time period of Z seconds, the determination unit 21 determines that a short time period has elapsed since the user's child leaves the stage, that is, the scene is a scene immediately after the predetermined subject is not detected. In this case, the determination unit 21 determines the degree of importance of the scene in the fourth phase “immediately after user's child is absent” as “1” in accordance with the degree-of-importance determination rule information 31.

Based on a state where the second camera 12 is performing a shooting operation, the camera controller 22 compares the determined degree of importance with the off threshold. Specifically, the camera controller 22 determines that the determined degree of importance “1” is higher than or equal to the off threshold “1”. The camera controller 22 thus keeps the shooting mode of the second camera 12. The second camera 12 thus continues the shooting operation of the scene in the fourth phase “immediately after user's child is absent”. Further, in this specific example, the mode definition information 33 also defines the shooting mode of the second camera 12 as the mode in which if the user's child leaves, shooting of the place where they have been present is still performed at the same zoom ratio. The second camera 12 thus performs the zoom shooting of the place immediately after the user's child leaves at the same power as that in the third phase, under the control of the camera controller 22.

It is also conceivable that a performer leaves the stage once but comes back in a short time in the place where they have been present. If frequent repetition of the appearance and leaving of the performer who is the predetermined subject on the stage occurs, switching the operation mode of the second camera 12 in response to the appearance or leaving of the performer results in fragmentary moving images. Fragmentarily shot moving images cause inconvenience such as poor visibility and management difficulty. Hence, as in the configuration described above, in consideration of the possibility of reappearance of the specific subject in a short time, switching to the low power consumption mode is not immediately performed despite the absence of the specific subject, and the second camera 12 keeps the shooting mode for the predetermined time period of Z seconds (for example, ten seconds). The shooting mode is thus kept without being influenced by the frequent repetition of the appearance and leaving of the predetermined subject, and the predetermined subject shot by the second camera 12 is included in one continuously moving image.

In the fifth phase “user's child absent, a moving image shot by the first camera 11 includes a scene where the user's child absent on the stage and where a predetermined time period has elapsed in this state. In the moving image, if a period of time longer than or equal to the predetermined time period of Z seconds has elapsed since the user's child leaves, the determination unit 21 determines that the predetermined subject is not detected. In this case, the determination unit 21 determines the degree of importance of the scene in the fifth phase “user's child absent” as “0” in accordance with the degree-of-importance determination rule information 31.

Based on the state where the second camera 12 is performing a shooting operation, the camera controller 22 compares the determined degree of importance with the off threshold. Specifically, the camera controller 22 determines that the determined degree of importance “0” is lower than the off threshold “1”. The camera controller 22 then performs switching of the operation mode of the second camera 12 from the shooting mode to the low power consumption mode. The second camera 12 thus does not shoot a moving image for the scene in the fifth phase “user's child absent”.

### Processing Flow

Like the controller device 10 according to Embodiment 2, the controller device 10 of the smartphone 1 according to Embodiment 3 executes the series of steps illustrated in FIG. 8.

### Degree-Of-Importance Determination Process

FIG. 12 is a flowchart illustrating an example flow of a degree-of-importance determination process executed by the determination unit 21 of the controller device 10 according to Embodiment 3. The series of steps illustrated in FIG. 12 corresponds to step S203 illustrated in FIG. 8.

In step SS21, the determination unit 21 determines whether the predetermined subject is detected in the first image generated by the first camera 11 in step S202. If the predetermined subject is detected in the first image, the determination unit 21 proceeds from YES in step SS21 to step SS22. If the predetermined subject is not detected in the first image, the determination unit 21 proceeds from NO in step SS21 to step SS23.

In step SS22, the determination unit 21 determines the degree of importance of the scene included in the first image as “2” based on the degree-of-importance determination rule information 31 stored in the memory unit 13.

In step SS23, the determination unit 21 determines whether the predetermined time period of Z seconds has elapsed since the predetermined subject is not detected. If the predetermined time period of Z seconds has not elapsed, the determination unit 21 proceeds from NO in step SS23 to step SS24. If the predetermined time period of Z seconds has elapsed, the determination unit 21 proceeds from YES in step SS23 to step SS25.

In step SS24, the determination unit 21 determines the degree of importance of the scene included in the first image as “1” based on the degree-of-importance determination rule information 31 stored in the memory unit 13.

In step SS25, the determination unit 21 determines the degree of importance of the scene included in the first image as “0” based on the degree-of-importance determination rule information 31 stored in the memory unit 13.

The determination unit 21 stores the degree of importance determined in step SS22, SS24, or SS25 in the buffer (not illustrated) to enable the camera controller 22 to refer to the degree of importance and terminates the series of steps in the degree-of-importance determination process.

As described above, in the controller device 10 of the smartphone 1 according to Embodiment 3, if an image shot by the first camera 11 includes the predetermined subject (for example, the user's child), the determination unit 21 decides a value (for example, 2) higher than or equal to the on threshold as the degree of importance of the scene. If the predetermined subject is absent in the image for a time period longer than or equal to the predetermined time period (for example, ten seconds), the determination unit 21 decides a value (for example, 0) lower than the off threshold as the degree of importance of the scene. If the predetermined subject is absent in the image for a time period shorter than the predetermined time period, the determination unit 21 decides a value that is higher than or equal to the off threshold and that is lower than the on threshold (for example, 1) as the degree of importance of the scene.

According to the configuration and the method that are described above, the power consumption is reduced, and the image of an important scene where the image of the predetermined subject is shot by the first camera 11, that is, where the predetermined subject is present is acquired also from the second camera 12. Moreover, even if the appearance and leaving of the subject are repeated at short intervals, frequent switching between performing and not performing the shooting operation of the second camera 12 is avoided.

### Modification

The determination unit 21 may determine the degree of importance of a scene by using a live view image among images generated by the first camera 11. The live view image is stored in a nonvolatile manner in the line buffer (not illustrated) or the like. Alternatively, the determination unit 21 may determine the degree of importance of the scene by using an image stored in the memory unit 13 in a nonvolatile manner.

The shooting operation to be performed by the second camera 12 in the shooting mode is not limited to those described in Embodiments 1 to 3 and may be shooting a still image, taking consecutive shots, or the like. For example, in the third phase “double jumping” in the specific example illustrated in FIG. 2, the first camera 11 shoots an ordinary moving image, and in contrast, the second camera 12 may shoot such a still image that clips a high-speed motion at a shutter speed or an ISO speed set in advance or may take consecutive shots.

The method by which the determination unit 21 learns the features of the predetermined subject is not limited to the method in which model data regarding the face of the predetermined subject is registered. For example, the determination unit 21 may perform the learning of the predetermined subject in the following manner. First, the user shoots an image of a subject intended to be set as the predetermined subject for the first camera 11, for predetermined seconds. At this time, the shooting is desirably performed to include an outfit such as a characteristic garment specific to the predetermined subject. A live view image captured by the first camera 11 is displayed on the display unit (not illustrated) of the smartphone 1. The user designates a subject intended as the predetermined subject in the live view image by using the operation unit 14. The camera controller 22 extracts the feature of the designated subject from the live view image and registers the feature as model data regarding the predetermined subject in the memory unit 13. In this the method, even in a case where the predetermined subject (for example, the user's child) with their face in daily life that is registered in advance is absent on the stage, learning the characteristic outfit on the stage enables the determination unit 21 to identify the predetermined subject intended by the user.

The number of cameras included in the electronic device is not limited to 2 and may be 3 or more. For example, an electronic device including one first camera 11 and two second cameras 12 are also included in the scope of the present disclosure. In this case, the first camera 11 performs a shooting operation in accordance with a user operation. A first second camera 12A performs a shooting operation different from that of the first camera 11 in accordance with the degree of importance determined by using an image shot by the first camera 11. A second camera 12B performs a shooting operation different from those of the first camera 11 and the second camera 12A in accordance with the degree of importance determined by using the image shot by the first camera 11.

### Example Implementation by Software

The control blocks of the controller device 10 (particularly, the determination unit 21 and the camera controller 22) may be implemented by a logic circuit (hardware) in the integrated circuit (IC chip) or the like or by software.

In the latter case, the controller device 10 includes a computer that executes a command in the program as the software for implementing the various functions. The computer includes, for example, at least one processor (controller device) and at least one computer readable recording medium storing the program. When reading the program from the recording medium and running the program by the processor in the computer, the present disclosure is thereby implemented. For example, a central processing unit (CPU) is usable as the processor. As the recording medium, a non transitory tangible medium such as a read only memory (ROM), tape, a disk, a card, a semiconductor memory, or a programmable logic circuit is usable. The controller device 10 may further include a random access memory (RAM) in which the program is loaded or the like. The program may be provided to the computer by using any transmission medium allowing the program to be transmitted (such as a communication network or a broadcast wave). An aspect of the present disclosure may be implemented in a form of a data signal embedded in a carrier wave and implemented as the program by electronic transmission.

### Summarization

An electronic device (the smartphone 1) according to a first aspect of the present disclosure includes the first camera 11 that performs a shooting operation in accordance with a user operation, at least one second camera 12 different from the first camera, and the controller device 10 that controls the first camera and the second camera. The controller device performs a determination process (steps S103 and S203) in which the degree of importance of a scene for the shooting operation is determined by using an image (a moving image or a still image) shot by the first camera and a camera control process (steps S105, S106, S207, and S208) in which switching of the operation mode of the second camera is performed based on the degree of importance. The switching is performed between a shooting mode in which a shooting operation is performed and a low power consumption mode in which power consumption is lower than power consumption in the shooting operation.

In the electronic device according to a second aspect of the present disclosure, in the first aspect, in the camera control process, the controller device may cause the second camera to operate in the shooting mode (steps S105 and S207) in response to high importance of the scene indicated by the determined degree of importance and may cause the second camera to operate in the low power consumption mode (steps S106 and S208) in response to low importance of the scene indicated by the determined degree of importance.

In the electronic device according to a third aspect of the present disclosure, in the first aspect, in the determination process, the controller device may determine the degree of importance of the scene by using a multi-level value on a scale of one to three or more. In the camera control process, the controller device may perform switching of the operation mode of the second camera to the shooting mode in response to a change of the determined degree of importance from a value lower than a first threshold (the on threshold) to a value higher than or equal to the first threshold. The controller device may perform switching of the operation mode of the second camera to the low power consumption mode in response to a change of the determined degree of importance from a value higher than or equal to a second threshold (the off threshold) that is lower than the first threshold to a value lower than the second threshold.

In the electronic device according to a fourth aspect of the present disclosure, in the third aspect, in the determination process, the controller device may decide, as the degree of importance of the scene, a value higher than or equal to the first threshold in response to the presence of a predetermined subject (a predetermined subject or a performer) in the predetermined range Y (the central area of the stage) in the scene in the image. The controller device may decide, as the degree of importance of the scene, a value lower than the second threshold in response to the absence of the predetermined subject in the image. The controller device may decide, as the degree of importance of the scene, a value that is higher than or equal to the second threshold and that is lower than the first threshold in response to the presence of the predetermined subject outside the predetermined range in the image.

In the electronic device according to a fifth aspect of the present disclosure, in the third aspect, in the determination process, the controller device may decide a value higher than or equal to the first threshold as the degree of importance of the scene in response to the presence of the predetermined subject in the image. The controller device may decide a value lower than the second threshold as the degree of importance of the scene in response to the absence of the predetermined subject in the image for a time period longer than or equal to the predetermined time period of Z seconds. The controller device may decide a value that is higher than or equal to the second threshold and that is lower than the first threshold as the degree of importance of the scene in response to the absence of the predetermined subject for a time period shorter than the predetermined time period.

In the electronic device according to a sixth aspect of the present disclosure, in any one of the first to third aspects, in the determination process, the controller device may decide the degree of importance of the scene to cause the degree of importance of a scene where a moving body moving at a speed higher than or equal to the predetermined speed X is detected in the image to be higher than the degree of importance of a scene where a moving body moving at a speed lower than the predetermined speed X is detected or where a moving body is not detected.

In the electronic device according to a seventh aspect of the present disclosure, in any one of the first to sixth aspects, the controller device desirably causes the second camera, in the shooting mode of the second camera, to perform a shooting operation different from a shooting operation performed by the first camera.

A controller device according to an eighth aspect of the present disclosure controls an electronic device including a first camera that performs a shooting operation in accordance with a user operation and at least one second camera different from the first camera. The controller device includes the determination unit 21 and the camera controller 22. The determination unit determines the degree of importance of a scene for the shooting operation. The degree of importance is determined by using an image shot by the first camera. The camera controller performs switching of the operation mode of the second camera based on the degree of importance. The switching is performed between a shooting mode in which a shooting operation is performed and a low power consumption mode in which power consumption is lower than power consumption in the shooting operation.

A control method according to a ninth aspect of the present disclosure is performed on an electronic device including a first camera that performs a shooting operation in accordance with a user operation and at least one second camera different from the first camera. The method includes determining (steps S103 and S203), by using an image shot by the first camera, the degree of importance of a scene for the shooting operation and camera controlling (steps S105, S106, S207, and S208) in which switching the operation mode of the second camera is performed based on the degree of importance. The switching is performed between a shooting mode in which a shooting operation is performed and a low power consumption mode in which power consumption is lower than the power consumption in the shooting operation.

The controller device 10 according to the aspects of the present disclosure may be implemented by a computer. In this case, a control program for the controller device 10 and a computer readable recording medium recording the control program are also included in the scope of the present disclosure. The computer operates as components of the controller device 10 (software elements) and thereby implements the controller device 10.

The present disclosure is not limited to the embodiments described above. Various modifications may be made within the scope of claims. An embodiment obtained by appropriately combining technical measures disclosed in different embodiments is also included in the technical scope of the present disclosure. Further, a new technical feature may be created by combining the technical measures disclosed in the embodiments.

For example, the optical systems of the plurality of cameras may be respectively provided for the plurality of cameras or may be shared by the plurality of cameras. For example, compound-eye lenses may be respectively provided for the plurality of cameras, or a single lens may be shared by the plurality of cameras.

While there have been described what are at present considered to be certain embodiments of the invention, it will be understood that various modifications may be made thereto, and it is intended that the appended claim cover all such modifications as fall within the true spirit and scope of the invention.

The present disclosure contains subject matter related to that disclosed in Japanese Priority Patent Application JP 2019-222824 filed in the Japan Patent Office on Dec. 10, 2019, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic device comprising:
a first camera that performs a shooting operation in accordance with a user operation;
at least one second camera different from the first camera; and
a controller device that controls the first camera and the second camera,
wherein the controller device performs
a determination process in which a degree of importance of a scene for the shooting operation is determined by using an image shot by the first camera and
a camera control process in which switching of an operation mode of the second camera is performed based on the degree of importance, the switching being performed between a shooting mode in which a shooting operation is performed and a low power consumption mode in which power consumption is lower than power consumption in the shooting operation.

2. The electronic device according to claim 1,
wherein in the camera control process,
the controller device
causes the second camera to operate in the shooting mode in response to high importance of the scene indicated by the determined degree of importance and
causes the second camera to operate in the low power consumption mode in response to low importance of the scene indicated by the determined degree of importance.

3. The electronic device according to claim 1,
wherein in the determination process,
the controller device determines the degree of importance of the scene by using a multi-level value on a scale of one to three or more, and
in the camera control process,
the controller device performs
switching of the operation mode of the second camera to the shooting mode in response to a change of the determined degree of importance from a value lower than a first threshold to a value higher than or equal to the first threshold and
switching of the operation mode of the second camera to the low power consumption mode in response to a change of the determined degree of importance from a value higher than or equal to a second threshold that is lower than the first threshold to a value lower than the second threshold.

4. The electronic device according to claim 3,
wherein in the determination process,
the controller device decides, as the degree of importance of the scene,
a value higher than or equal to the first threshold in response to presence of a predetermined subject in a predetermined range in the scene in the image,
a value lower than the second threshold in response to absence of the predetermined subject in the image, and
a value that is higher than or equal to the second threshold and that is lower than the first threshold in response to presence of the predetermined subject outside the predetermined range in the image.

5. The electronic device according to claim 3,
wherein in the determination process,
the controller device decides
a value higher than or equal to the first threshold as the degree of importance of the scene in response to presence of the predetermined subject in the image,
a value lower than the second threshold as the degree of importance of the scene in response to absence of the predetermined subject in the image for a time period longer than or equal to a predetermined time period, and
a value that is higher than or equal to the second threshold and that is lower than the first threshold as the degree of importance of the scene in response to absence of the predetermined subject for a time period shorter than the predetermined time period.

6. The electronic device according to claim 1,
wherein in the determination process,
the controller device
decides the degree of importance of the scene to cause the degree of importance of a scene where a moving body moving at a speed higher than or equal to a predetermined speed is detected in the image to be higher than the degree of importance of a scene where a moving body moving at a speed lower than the predetermined speed is detected or where a moving body is not detected.

7. The electronic device according to claim 1,
wherein the controller device
causes the second camera, in the shooting mode of the second camera, to perform a shooting operation different from a shooting operation performed by the first camera.

8. A controller device that controls an electronic device including a first camera that performs a shooting operation in accordance with a user operation and at least one second camera different from the first camera, the controller device comprising:
a determination unit that determines a degree of importance of a scene for the shooting operation, the degree of importance being determined by using an image shot by the first camera; and
a camera controller that performs switching of an operation mode of the second camera based on the degree of importance, the switching being performed between a shooting mode in which a shooting operation is performed and a low power consumption mode in which power consumption is lower than power consumption in the shooting operation.

9. A control method for an electronic device including a first camera that performs a shooting operation in accordance with a user operation and at least one second camera different from the first camera, the method comprising:
determining, by using an image shot by the first camera, a degree of importance of a scene for the shooting operation; and
camera controlling in which switching an operation mode of the second camera is performed based on the degree of importance, the switching being performed between a shooting mode in which a shooting operation is performed and a low power consumption mode in which power consumption is lower than the power consumption in the shooting operation.
